(19) United States
(12) Patent Application Publication
(10) Pub. No.: US 2016/0372026 A1
(43) Pub. Date: Dec. 22, 2016

(54) NON-RECTANGULAR DISPLAY AND DRIVING METHOD FOR THE SAME

(71) Applicant: SHENZHEN CHINA STAR OPTOLECTRONIC TECHNOLOGY CO., LTD., Shenzhen, Guangdong (CN)

(72) Inventor: Chih-hao WU, Shenzhen, Guangdong (CN)

(73) Assignee: Shenzhen China Star Optoelectronics Technology Co., Shenzhen, Guangdong (CN)

(21) Appl. No.: 14/438,603

(22) PCT Filed: Mar. 4, 2015
(86) PCT No.: PCT/CN2015/073631

§ 371 Date: Apr. 24, 2015

(30) Foreign Application Priority Data
Feb. 5, 2015 (CN) 201510065052

(51) Int. Cl. G09G 3/20; G09G 3/3258; G09G 3/36; G09G 3/3266

(52) U.S. Cl. CPC G09G 3/2096; G09G 3/3266; G09G 3/3258; G09G 3/3655; G09G 3/3677; G09G 2330/021; G09G 2300/0809; G09G 2300/0842

(57) ABSTRACT

A non-rectangular display and a driving method for the same are disclosed. The driving method comprises: detecting a width of each pixel unit row in a pixel unit array; determining a driving signal of the pixel unit array according to the width of each pixel unit row, wherein, an operation period of a driving pulse of the driving signal at one pixel unit row corresponds to the width of the one pixel unit row; and using the driving signal to drive the pixel unit array. Through above way, the scanning time is saved and the power consumption for driving is reduced. Accordingly, the cost is saved and the efficiency is increased.

### BACKGROUND OF THE INVENTION

1. Field of the Invention

The present invention relates to display technology field, and more particularly to a non-rectangular display and a driving method for the same.

2. Description of Related Art

With increasingly popular of wearable devices such as smart watches and so on, the demand for a non-rectangular display is also growing.

Currently, pixel driving method of a non-rectangular display still utilizes the pixel driving method for the conventional rectangular display. The driving pulses of driving method are useless at an ineffective display area such that a portion of the driving pulses are meaningless. Therefore, the scanning time is increased and the power consumption required for driving is also increased so that the driving method is not conducive for saving cost and improving efficiency.

Therefore, a driving method for a non-rectangular display is required to solve the above technology problems.

### SUMMARY OF THE INVENTION

The main technology problem solved by the present invention is to provide a non-rectangular display and a driving for the same, which is capable of increasing the driving efficiency and saving the power consumption required for driving.

In order to solve the above technology problem, a technology solution utilized by the present invention is to provide a driving method for a non-rectangular display, comprising: detecting a width of each pixel unit row in a pixel unit array; determining a driving signal of the pixel unit array according to the width of each pixel unit row, wherein, an operation period of a driving pulse of the driving signal at one pixel unit row corresponds to the width of the one pixel unit row; and using the driving signal to drive the pixel unit array; wherein, the step of detecting a width of each pixel unit row in a pixel unit array includes: detecting the number of the pixel units in each pixel unit row; wherein, the step of determining a driving signal of the pixel unit array according to the width of each pixel unit row includes: determining an unit operation period of the driving pulse required by one pixel unit; and wherein, the driving signal includes a data signal and a scanning signal; the step of using the driving signal to drive the pixel unit array: controlling a period that the pixel unit row is connected with the data signal through the scanning signal, wherein the data signal provides the driving pulse.

In order to solve the above technology problem, another technology solution utilized by the present invention is to provide a driving method for a non-rectangular display, comprising: detecting a width of each pixel unit row in a pixel unit array; determining a driving signal of the pixel unit array according to the width of each pixel unit row, wherein, an operation period of a driving pulse of the driving signal at one pixel unit row corresponds to the width of the one pixel unit row; and using the driving signal to drive the pixel unit array.

Wherein, the step of detecting a width of each pixel unit row in a pixel unit array includes: detecting the number of the pixel units in each pixel unit row; wherein, the step of determining a driving signal of the pixel unit array according to the width of each pixel unit row includes: determining an unit operation period of the driving pulse required by one pixel unit; according to the number of the pixel units of each pixel unit row 111 and the unit operation period to determine the operation period of the driving pulse of the pixel unit rows.

Wherein, the driving signal includes a data signal and a scanning signal; the step of using the driving signal to drive the pixel unit array: controlling a period that the pixel unit row is connected with the data signal through the scanning signal, wherein the data signal provides the driving pulse.

In order to solve the above technology problem, another technology solution utilized by the present invention is to provide a non-rectangular display, comprising: a substrate; a pixel unit array disposed on the substrate and including multiple pixel unit rows; and a driving module connected with the substrate for detecting a width of each pixel unit row of the pixel unit array, and according to the width of each pixel unit row to determine a driving signal of the pixel unit array; wherein, an operation period of a driving pulse of the driving signal at one of the pixel unit rows is corresponding to the width of the one of the pixel unit rows; driving module also utilizes the driving signal to drive the pixel unit array.

Wherein, an area covered by the pixel unit array is an effective display area of the non-rectangular display; the pixel units are arranged along a direction which is in parallel with a portion of edges of the effective display area.

Wherein, two opposite edges of the effective display area are in parallel with each other, and the pixel units are arranged in parallel with a longest edge of the two opposite edges.

Wherein, the effective display area is a polygon and an axis-symmetrical shape; a longest edge of the polygon is an upper edge with a “V” shape; an edge which is in parallel with the upper edge is a lower edge with a “V” shape; a symmetrical axis “A” of the polygon pass through vertexes of the upper edge and the lower edge; besides, the upper edge and the lower edge are symmetrical with respect to the symmetrical axis “A” of the polygon.

Wherein, the effective display area is an axis-symmetrical shape; a longest edge is a curved upper edge, and an edge which is in parallel with the upper edge is a curved lower edge; a symmetrical axis of the effective display area passes through middle points of the upper edge and the lower edge; the upper edge and the lower edge are both symmetrical with respect to the symmetrical axis of the effective display area.

Wherein, an area covered by the pixel unit array is an effective display area of the non-rectangular display. The effective display area is a circular shape. The pixel unit rows 111 are arranged in parallel with a diameter direction of the circular shape or arranged along the diameter direction of the circular shape.

Wherein, the non-rectangular display is a liquid crystal display or an organic light-emitting diode (OLED).

Comparing to the conventional art, the present invention determines the driving signal of the pixel unit array according to the width of each pixel unit row such that the operation period of the driving pulse of the driving signal at one pixel unit row corresponds to the width of the pixel unit row. Then, using the driving signal to drive the pixel unit array. Through above way, the scanning time is saved and the power consumption for driving is reduced. Accordingly, the cost is saved and the efficiency is increased.

### BRIEF DESCRIPTION OF THE DRAWINGS

FIG. 1 is a schematic diagram of a non-rectangular display according to a preferred embodiment of the present invention;

FIG. 2 is a circuit principle diagram of a pixel unit of an active matrix liquid crystal display according to the present invention;

FIG. 3 is a circuit principle diagram of a pixel unit of an active matrix light emitting diode (LED) display according to the present invention;

FIG. 4 is a waveform diagram of scanning signal of driving signal according to the present invention;

FIG. 5 is schematic arrangement diagram of a pixel unit array and a shape of a non-rectangular display according to another embodiment of the present invention;

FIG. 6 is schematic arrangement diagram of a pixel unit array and a shape of a non-rectangular display according to another embodiment of the present invention;

FIG. 7 is schematic arrangement diagram of a pixel unit array and a shape of a non-rectangular display according to another embodiment of the present invention; and

FIG. 8 is a flowchart of a driving method of a non-rectangular display according to the present invention.

### DETAILED DESCRIPTION OF THE PREFERRED EMBODIMENT

The following will combine the drawings for further description of the present invention.

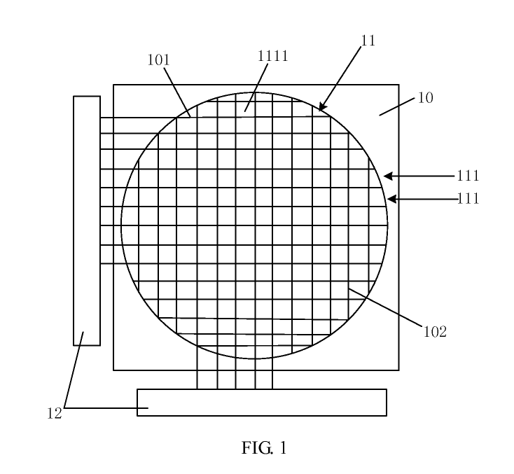

With reference to FIG. 1, FIG. 1 is a schematic diagram of a non-rectangular display according to a preferred embodiment of the present invention. The non-rectangular display includes: a substrate 10, a pixel unit array 11 and a driving module 12. The pixel unit array 11 is disposed on the substrate 10 and the pixel unit array 11 includes multiple pixel unit rows 111. The driving module 12 is connected with the substrate 10 for detecting a width of each pixel unit row 111 of the pixel unit array 11, and according to the width of each pixel unit row 111, the driving signal of the pixel unit array 11 is determined. Wherein, an operation period of a driving pulse of the driving signal in one of the pixel unit rows 111 is corresponding to the width of the one of the pixel unit rows 111. The driving signal is used for driving the pixel unit array 11. The driving module 12 is disposed in an ineffective display area, wherein, the ineffective display area is an area that is not covered by the pixel units 1111.

The driving module 12 detects the width of each pixel unit row 111 of the pixel unit array 11. Specifically, the driving module 12 detects the number of the pixel units 1111 of each pixel unit row 111. The driving module 12 determines the driving signal of the pixel unit array 11 according to the width of each pixel row 111. Specifically, at first, the driving module 12 determines a unit operation period of a driving pulse required for one pixel unit 1111. Then, according to the number of the pixel units 1111 of each pixel unit row 111 and the unit operation period to determine the operation period of the driving pulse of the pixel unit rows 111. Preferably, an operation period of a driving pulse of one pixel unit row 111 equals to the number of pixel units 1111 in the one pixel unit row 111 multiplied by a unit operation period.

The driving signal includes a data signal and a scanning signal. The driving module 12 utilizes the driving signal to drive the pixel unit array 11. Specifically, the driving module 12 controls a period that the pixel unit row 111 is connected with the data signal through the scanning signal. Wherein, the data signal provides the driving pulse.

Specifically, the pixel unit array 11 includes the pixel units 1111 arranged as a matrix. The substrate 10 further includes multiple row conductors 101 and column conductors 102. Each pixel unit row 111 shares a common row conductor 101, and each pixel unit column share a common column conductor 102.

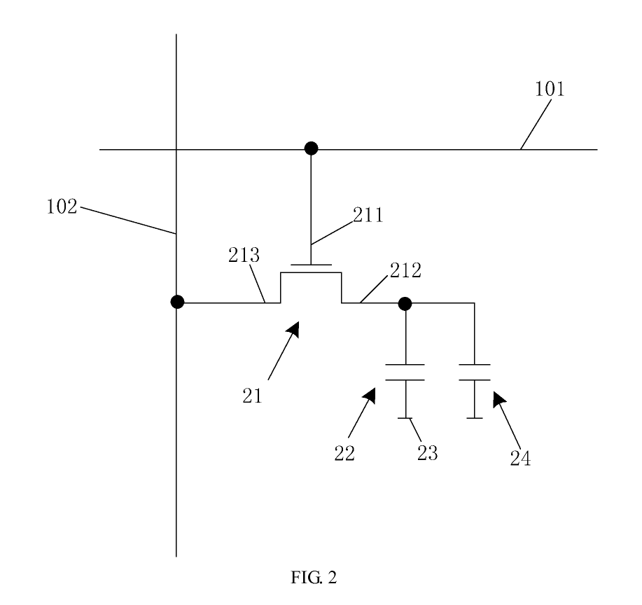

With further reference to FIG. 2, FIG. 2 is a circuit principle diagram of a pixel unit of an active matrix liquid crystal display according to the present invention. For example, in an active matrix liquid crystal display, each pixel unit 1111 includes a thin film transistor 21 and a liquid crystal unit 22. The substrate 10 further includes a common electrode 23. The thin film transistor 21 and the liquid crystal unit 22 are arranged in series between the column conductor 102 and the common electrode 23. The driving module 12 is connected with the row conductors 101 and the column conductors 102. The driving module 12 also provides the scanning signal to the row conductors 101 and provides the data signal to the column conductor 102. The row conductor 101 is a gate electrode 211 of each thin film transistor 21 in a corresponding pixel unit row 111. The column conductor 102 is connected with a source electrode 213 of the thin film transistor 21 such that the thin film transistor 21 is turned on or off through the scanning signal provided by the row conductor 101.

As a result, when the scanning signal controls a row of the thin film transistors 21 to be turned on, that is, a drain electrode 212 is electrically connected with the source electrode 213 such that the column conductor 102 is electrically connected with the drain electrode 212 of each thin film transistor 21 in a corresponding pixel unit row 111. Therefore, the data signal acts on the liquid crystal unit 22, that is, the driving pulse of the data signal on the column conductor 102 acts on the pixel unit row 111. Through the scanning signal to control a turned on period of the thin film transistor 21 in order to control a period that the pixel unit row 111 is connected with the data signal. Each pixel unit 1111 further includes a storage capacitor 24. One terminal of storage capacitor 24 is connected with a next electrode, a previous electrode or an electrode of an independent capacitor. The other terminal of the storage capacitor 24 is connected with a drain electrode of a corresponding thin film transistor. Capacitors (the storage capacitor or a parasitic capacitor) of a pixel unit 1111 can store a driving voltage such that even the thin film transistor 21 is turned off, the data signal can still be maintained on the liquid crystal unit 22 so as to change the light penetration property of the liquid crystal unit 22 in order to realize different display effects.

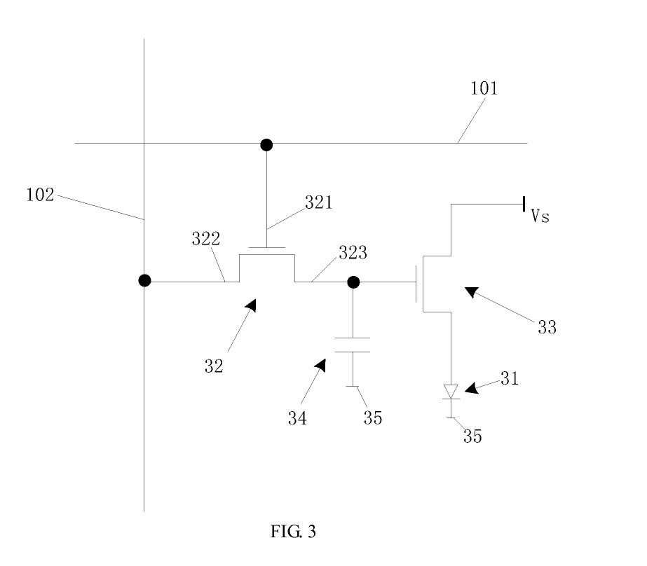

Similarly, with reference to FIG. 1 and FIG. 3, FIG. 3 is a circuit principle diagram of a pixel unit of an active matrix light emitting diode (LED) display according to the present invention. For example, in an active matrix light emitting diode display (OLED), each pixel unit row 111 shares a common row conductor 101. Each pixel unit column shares a common column conductor 102. The pixel unit includes an organic light emitting diode 31, a switching thin film transistor 32, a driving thin film transistor 33 and a storage capacitor 34. The substrate 10 includes a common electrode 35, the thin film transistor 32, and the storage capacitor 34 are arranged in series between the column conductor 102 and the common electrode 35. The driving module 12 is connected with the row conductor 101 and the column conductor 102. The driving module 12 also provides a scanning signal to the row conductor 101, and provides a data signal to the column conductor 102.

The row conductor 101 is connected with a gate 321 of each switching thin film transistor 32 in a corresponding pixel unit row 111. The column conductor 102 is connected with a source electrode 322 of each switching thin film transistor 32. As a result, when the scanning signal controls a row of the switching thin film transistors 32 to be turned on, that is, a source electrode 322 of the switching thin film transistor 32 is electrically connected with a drain electrode 323 such that the column conductor 102 is electrically connected with the drain electrode 323 of each switching thin film transistor 32 in a corresponding pixel unit row 111. The storage capacitor 34 is charged by the data signal on the column conductor 102. After the storage capacitor 34 is charged, when the switching thin film transistor 32 is turned off, the storage capacitor 34 discharges to the thin film transistor 33 for switching such that a voltage source Vs flows through the organic light emitting diode 31 to emit the lights in order to realize a display effect.

Preferably, in the present embodiment, an area covered by the pixel unit array 11 is an effective display area of the non-rectangular display. The effective display area is a circular shape. The pixel unit rows 111 are arranged in parallel with a diameter direction of the circular shape or arranged along the diameter direction of the circular shape.

With reference to FIG. 4, FIG. 4 is a waveform diagram of scanning signal of driving signal according to the present invention. Wherein, a high voltage level represent that a corresponding thin film transistor is turned on, and a low voltage level represent that a corresponding thin film transistor is turned off. An operation period of a driving pulse of a driving signal at one pixel unit row 111 is corresponding to a width of the one pixel unit row 111. When a width of a pixel unit row 111 is larger, an operation period corresponding to the pixel unit row 111 is longer.

In another embodiment of a non-rectangular display of the present invention, an arrangement way of pixel units in a pixel unit array is further changed. The specific detail is described below.

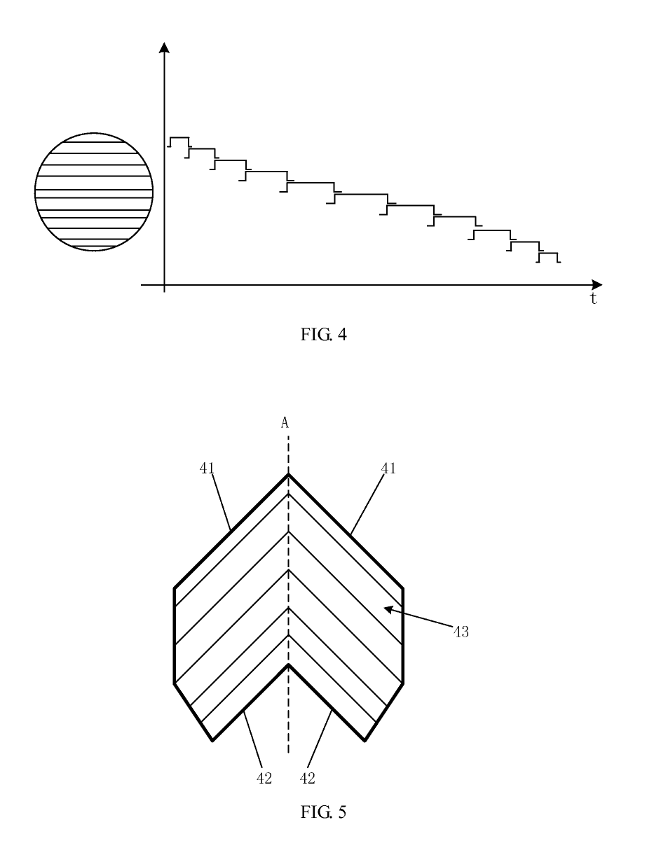

FIG. 5 is schematic arrangement diagram of a pixel unit array and a shape of a non-rectangular display according to another embodiment of the present invention. In the present embodiment, an area covered by the pixel unit array 11 is an effective display area of the non-rectangular display. Pixel unit rows 111 are arranged in parallel with a portion of edges of the effective display area. By the above way, the number of rows of the pixel unit rows is reduced.

Preferably, two opposite edges 41 and 42 of the effective display area are in parallel with each other. The pixel unit rows are arranged along the longest edge 41 of the two opposite edges. Furthermore, the arrangement way can effectively distribute the space in order to reduce the ineffective display area.

Preferably, the effective display area is a polygon and an axis-symmetrical shape. The longest edge is an upper edge 41 with a “V” shape. The edge which is in parallel with the upper edge 41 is a lower edge 42 also having a “V” shape. A symmetrical axis “A” of the polygon passes through vertexes of the upper edge 41 and the lower edge 42. Besides, the upper edge 41 and the lower edge 42 are symmetrical with respect to the symmetrical axis “A” of the polygon. In FIG. 5, the lines expect the upper edge 41 and the lower edge 42 connect the upper edge 41 and the lower edge 42 to form the closed polygon. In another embodiment, it can be understood that the present invention can be realized through other curved lines or more complicated curved lines to form the closed polygon or other irregular shape.

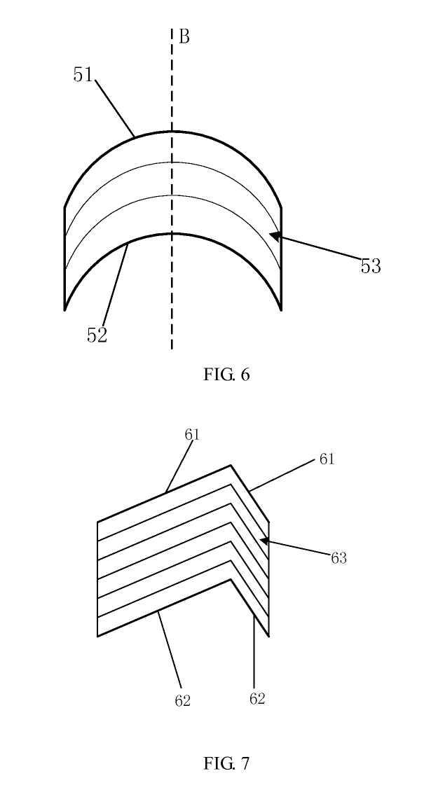

Of course, in another embodiment, with reference to FIG. 6, FIG. 6 is schematic arrangement diagram of a pixel unit array and a shape of a non-rectangular display according to another embodiment of the present invention. In the present invention, the effective display area is an axis-symmetrical shape. The longest edge 51 is a curved upper edge 51, and a lower edge 52 which is in parallel with the edge 51 is curved. A symmetrical axis “B” of the effective display area passes through middle points of the upper edge 51 and the lower edge 52. The upper edge 51 and the lower edge 52 are both symmetrical with respect to the symmetrical axis “B” of the effective area.

In FIG. 6, the lines expect the upper edge 51 and the lower edge 52 connect the upper edge 51 and the lower edge 52 to form a closed shape. In another embodiment, it can be understood that the present invention can be realized through other curved lines or more complicated curved lines to form the closed shape.

With reference to FIG. 7, FIG. 7 is schematic arrangement diagram of a pixel unit array and a shape of a non-rectangular display according to another embodiment of the present invention. In the present invention, the effective display area is a polygon, and is an asymmetric shape. The longest edge is a curved upper edge 61, and the edge 62 which is in parallel with the upper edge 61 is curved lower edge 62.

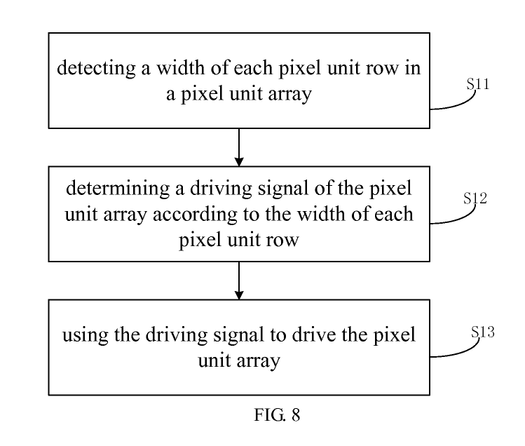

With reference to FIG. 8 and combined with reference to FIG. 1, FIG. 8 is a flowchart of a driving method of a non-rectangular display according to the present invention. In the present embodiment, the driving method of the non-rectangular display includes the following steps:

Step S11: detecting a width of each pixel unit row in a pixel unit array.

In the step S11, for example, utilizing the driving module 12 to detect the width of each pixel unit row 111 in the pixel unit array 11. Specifically: detecting the number of the pixel units 1111 in each pixel unit row 111.

Step S12: determining a driving signal of the pixel unit array according to the width of each pixel unit row.

In the step S12, an operation period of a driving pulse of the driving signal at one pixel unit row 111 corresponds to the width of the one pixel unit row 111. Specifically, the driving module 12 determines a unit operation period of the driving pulse required for one pixel unit 1111; according to the number of the pixel units 1111 of each pixel unit row 111 to determine the operation period of the driving pulse at the pixel unit rows 111. Preferably, the operation period of the driving pulse of one pixel unit row 111 equals to the number of pixel units 1111 in the one pixel unit row 111 multiplied by the unit operation period.

Step S13: using the driving signal to drive the pixel unit array.

In step S13, the driving signal includes a data signal and a scanning signal; the step of using the driving signal to drive the pixel unit array 11 includes: controlling a period that the pixel unit row is connected with the data signal through the scanning signal, wherein the data signal provides the driving pulse. The specific description can refer to the above description, no more repeat here.

Comparing to the conventional art, the present invention determines the driving signal of the pixel unit array according to the width of each pixel unit row such that the operation period of the driving pulse of the driving signal at one pixel unit row corresponds to the width of the pixel unit row. Then, using the driving signal to drive the pixel unit array. Through above way, the scanning time is saved; the power consumption for driving is reduced. Accordingly, the cost is saved and the efficiency is increased.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A driving method for a non-rectangular display, comprising:
detecting a width of each pixel unit row in a pixel unit array;
determining a driving signal of the pixel unit array according to the width of each pixel unit row, wherein, an operation period of a driving pulse of the driving signal at one pixel unit row corresponds to the width of the one pixel unit row; and
using the driving signal to drive the pixel unit array;
wherein, the step of detecting a width of each pixel unit row in a pixel unit array includes: detecting the number of the pixel units in each pixel unit row;
wherein, the step of determining a driving signal of the pixel unit array according to the width of each pixel unit row includes: determining a unit operation period of the driving pulse required by one pixel unit; and
wherein, the driving signal includes a data signal and a scanning signal; the step of using the driving signal to drive the pixel unit array: controlling a period that the pixel unit row is connected with the data signal through the scanning signal, wherein the data signal provides the driving pulse.

2. A driving method for a non-rectangular display, comprising:
detecting a width of each pixel unit row in a pixel unit array;
determining a driving signal of the pixel unit array according to the width of each pixel unit row, wherein, an operation period of a driving pulse of the driving signal at one pixel unit row corresponds to the width of the one pixel unit row; and
using the driving signal to drive the pixel unit array.

3. The driving method according to claim 2, wherein, the step of detecting a width of each pixel unit row in a pixel unit array includes: detecting the number of the pixel units in each pixel unit row;
wherein, the step of determining a driving signal of the pixel unit array according to the width of each pixel unit row includes: determining a unit operation period of the driving pulse required by one pixel unit;
according to the number of the pixel units of each pixel unit row 111 and the unit operation period to determine the operation period of the driving pulse of the pixel unit rows.

4. The driving method according to claim 2, wherein, the driving signal includes a data signal and a scanning signal; the step of using the driving signal to drive the pixel unit array: controlling a period that the pixel unit row is connected with the data signal through the scanning signal, wherein the data signal provides the driving pulse.

5. A non-rectangular display, comprising:
a substrate;
a pixel unit array disposed on the substrate and including multiple pixel unit rows; and
a driving module connected with the substrate for detecting a width of each pixel unit row of the pixel unit array, and according to the width of each pixel unit row to determine a driving signal of the pixel unit array;
wherein, an operation period of a driving pulse of the driving signal at one of the pixel unit rows is corresponding to the width of the one of the pixel unit rows;
driving module also utilizes the driving signal to drive the pixel unit array.

6. The non-rectangular display according to claim 5, wherein, an area covered by the pixel unit array is an effective display area of the non-rectangular display; the pixel units are arranged along a direction which is in parallel with a portion of edges of the effective display area.

7. The non-rectangular display according to claim 6, wherein, two opposite edges of the effective display area are in parallel with each other, and the pixel units are arranged in parallel with a longest edge of the two opposite edges.

8. The non-rectangular display according to claim 7, wherein, the effective display area is a polygon and an axis-symmetrical shape; a longest edge of the polygon is an upper edge with a “V” shape; an edge which is in parallel with the upper edge is a lower edge with a “V” shape; a symmetrical axis “A” of the polygon pass through vertexes of the upper edge and the lower edge; besides, the upper edge and the lower edge are symmetrical with respect to the symmetrical axis “A” of the polygon.

9. The non-rectangular display according to claim 7, wherein, the effective display area is an axis-symmetrical shape; a longest edge is a curved upper edge, and an edge which is in parallel with the upper edge is a curved lower edge; a symmetrical axis of the effective display area passes through middle points of the upper edge and the lower edge; the upper edge and the lower edge are both symmetrical with respect to the symmetrical axis of the effective display area.

10. The non-rectangular display according to claim 5, wherein, an area covered by the pixel unit array is an effective display area of the non-rectangular display. The effective display area is a circular shape. The pixel unit rows 111 are arranged in parallel with a diameter direction of the circular shape or arranged along the diameter direction of the circular shape.

11. The non-rectangular display according to claim 5, wherein, the non-rectangular display is a liquid crystal display or an organic light-emitting diode (OLED).
